(19) United States
(12) Patent Application Publication
(10) Pub. No.: US 2002/0189065 A1
(43) Pub. Date: Dec. 19, 2002

(54) Apparatus and method for applying anchor clips to furniture rails

(75) Inventor: Thomas Pruyne, Gurnee, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Stanley Fastening Systems

(21) Appl. No.: 10/150,661

(22) Filed: May 16, 2002

Related U.S. Application Data
(60) Provisional application No. 60/291,915, filed on May 18, 2001.

(51) Int. Cl. B68G 7/00; B68G 15/00

(52) U.S. Cl. 29/91.1; 29/91.7

(57) ABSTRACT

An apparatus and method for high-speed application of anchor clips to furniture rails are provided. The present invention preferably utilizes a conventional type of fastener power tool that is adapted and retrofit for use on the present machine and which has a much faster cycle rate than the toggle press tool of prior machines. The apparatus can also include a clip sensing mechanism that has a generally universal adjustable mounting system to provide significant flexibility in the types of rails that can be clipped therewith. The clip sensor is mounted in spaced relation to and preferably above the support on which the rail is guided as it is pushed through the clipping station so that non-linear rails can also be clipped. Preferably, the clip feeding mechanism of the present clipping machine is simplified versus feed mechanisms of prior machines.

### FIELD OF THE INVENTION

The invention relates to an apparatus and method for applying pronged anchor clips to furniture rails.

### BACKGROUND OF THE INVENTION

Machines for applying anchor clips to rails of wood or other material used in furniture are generally of two types: either fully automated (see U.S. Pat. No. 4,224,731 to Lingle) where the rails are run through the machine and clipped without significant operator intervention, or semi-automatic where the operator has to guide and push the furniture rail through the machine's clipping station. In those automated and semi-automatic machines of the predecessor to the assignee herein, there are several common features. In particular, the operating tool and the clip feeding mechanism shown in the '731 patent are generally common to both the '731 automated machine and to the commercial semi-automatic machine.

As described in the '731 patent, the pneumatic tool drives a piston rod having a toggle link pivoted to its distal end at one end of the link. The other end of the link is pivoted to a driver so that as the piston rod advances generally horizontally, the toggle link will cause the driver to shift downwardly. In this manner, the prior tool provided a mechanical advantage via a toggle press-like construction as described for breaking a clip off from the string of collated clips to which it is attached and driving it into the wood furniture rail. While the link toggle press provides the necessary force for separating the clip, it suffers from an operating cycle that is slower than desired. In addition, the pivots between the various driven members in the tool introduce moving parts and complications that can lead to increased maintenance levels and premature failure of the operating components.

A similar situation exists with the clip feed mechanism which currently utilizes an air cylinder for driving a bell crank lever at one end so that the lever pivots and retracts a clip engaging pawl along the string of clips with a spring assist for lifting the pawl out from a hole in the clip. When a clip is to be advanced, the cylinder retracts and a spring pivots the crank lever so that the pawl re-engages in the hole of a clip and pushes the clip string so that a leading clip is in position at the clipping station for being applied to a furniture rail. As is apparent, this is a fairly complicated mechanism utilizing a high number of moving parts and, with the large number of pivots and springs, increases chances for malfunction and failure.

In the semi-automatic machine, a clip sensing assembly is utilized for setting of a predetermined distance between clips applied to the furniture rail. However, this sensing assembly only functions with straight or linearly configured furniture rails. In the past, because most furniture rails had this configuration and were of standard sizes and wood types, this was not a problem. However, the furniture industry today utilizes rails with a wide variety of configurations diverting from the past standard sizes as well being crafted from many different wood types. Large furniture manufactures today often use CNC routers that can make furniture frame parts in seemingly unlimited configurations including cutting out whole sides of chairs or using sheet-like pieces that fit together with notches and slots in a jigsaw puzzle-like fashion. The spot market for wood can also be volatile and be a contributing factor to the wood size that is available and thus which needs to be processed with these clip applicator machines. Finally, the retail market is also demanding more changes in furniture constructions than ever before, particularly with the relatively recent advent of furniture that is adapted for more temporary or short-term usage so that it will be replaced more often, as well more as more seasonal furniture. Accordingly, this leads to more rapid turnover and changes in the styling of the furniture as people desire more selections for this type of more regularly purchased furniture.

Due to the above-described changes in the furniture industry, the lack of flexibility of prior clip sensing assemblies can render the machine virtually useless for a large percentage of the furniture rails to be clipped. More particularly, the sensing assembly has a sensor that is mounted for shifting to and from the clipping station substantially parallel to the direction the linear furniture rails extend. Further, the adjustable mount includes rails that are mounted at approximately the same level as the support on which the furniture rails are guided. With curved rails or rails having offset portions, generally it is necessary to be able to access this area downstream and behind the clipping station so that a portion of the curved rail can extend therein during clipping operations. With the mounting of current clip sensing assemblies in this area, such access is not provided. Also, for example, clipping on a continuously curved portion of the rail utilizing the sensing assembly for establishing predetermined distances between the clips is not possible for the above reasons as well as due to the fact that the sensor is only adjustable along the linear direction in which a straight furniture rail extends.

Accordingly, there is a need for an apparatus and method for applying clips to furniture rails in a high speed manner. Further, such an apparatus that has a simplified construction would be desirable, particularly from a reliability and maintenance standpoint. Finally, an apparatus and method that allows clipping of rails having curved portions is needed.

### SUMMARY OF THE INVENTION

In accordance with the present invention, an apparatus and method for high-speed application of anchor clips to furniture rail is provided. In this regard, the present apparatus is significantly simplified in its construction. In particular, with respect to the operating tool, there is no longer the large number of pivoting members relied on to gain the force necessary for breaking the clip off from the collated string as in prior tools for these types of clipping machines. Instead, the present invention utilizes a conventional nail gun power tool that is adapted and retrofit for use on the present machine and which has a much faster cycle rate than the previously described toggle press tool of prior machines.

To this end, the preferred tool includes a housing having a single drive rod that is powered for reciprocating and driving a ram adapted to engage the clips at a high velocity, e.g. having an average travel rate of approximately 1180 inches per second. Thus, it is the speed of operation of the power tool herein that provides the force necessary to break a clip off from the collated string of clips and drive it into the furniture rail as opposed to the slower moving drive mechanism of the prior tools which used the mechanical linkages to gain a mechanical advantage for achieving the breakage force necessary on the clip. Thus, the apparatus herein utilizing the present tool can achieve much faster cycle times in a much more reliable manner than previously obtained.

In another aspect of the invention, the apparatus includes a clip sensing mechanism that has a generally universal adjustable mounting system to provide significant flexibility in the types of rails that can be clipped therewith. In the preferred form, the adjustment mount for the clip sensor allows it to be adjusted in at least two directions that are transverse to each other. For example, the prior machine allowed the sensor to be adjustable in a longitudinal direction substantially parallel to that in which the straight pieces of wood extended, as previously described. The present machine has an adjustable mount for the clip sensor that allows this adjustment as well as allowing for adjustment thereof in a direction transverse to the longitudinal direction, preferably substantially normal thereto so that the clip sensor can be moved in and out relative to the front of the machine as well as forward and backward relative to the travel direction of a linear piece of wood through the machine. Thus, for pieces that extend other than linearly for their entire extent, any offset portion or curved portion can utilize the clip sensor by coordinating the adjustment thereof in the two different directions so that as the non-linear portion is being clipped it will advance towards the clip sensor to bring the just-applied clip into contact therewith, as will be described more fully hereinafter.

An additional advantage provided by the present clip sensor is that it is mounted in spaced relation to and preferably over and above the support on which the rail is guided as it is pushed through the pushing station. In this manner, any non-linear portion of the rail can start in the area adjacent and behind the clipping station to allow a linear portion extending therefrom to be clipped. To this end, the clip sensor preferably includes a cylinder and plunger assembly that depends downwardly from the cylinder and which is retracted upwardly toward the cylinder when engaged by a clip for sensing thereof. With the aforementioned non-linear furniture piece, the plunger assembly can be initially started in its up position to provide clearance therefor in this area, if needed. Prior machines do not provide this capability due to the mounting and orientation of the sensor assembly, as previously described.

Another aspect of the invention is the considerable simplification of the clip feeding mechanism herein. Instead of the large number of parts, pivots, and springs as in the clip feeding mechanism used in prior machines, the present clip feeding mechanism has an air cylinder that operates to drive its plunger and an associated pawl in the same linear direction as each other which is the same linear direction that the pawl pushes the clips in for feeding the leading clip into alignment with the power operating tool. In this manner, the number of parts and complicated pivot linkages is substantially minimized.

### BRIEF DESCRIPTION OF THE DRAWINGS

FIG. 1 is a perspective view of a machine for applying anchor clips in accordance with the present invention showing a frame assembly mounting a tray for holding the coiled string of collated clips, a clipping station for driving the clips into a furniture rail, and a sensing assembly for detecting applied clips;

FIGS. 1A and 1B are perspective views of the machine of FIG. 1 showing linear and non-linear furniture rails, respectively, advanced therethrough;

FIG. 2 is a front elevational view of the machine of FIG. 1;

FIG. 3 is a plan view of the machine of FIG. 1 schematically showing clips fed from the tray assembly toward the clipping station;

FIG. 4 is a side elevational view of the machine of FIG. 1 showing an extruded primary portion of the frame assembly with a removable arm mount for supporting the tray assembly;

FIG. 5 is a front elevational view partially in section of a power tool at the clipping station having a drive shaft depending therefrom, and a feed mechanism including a power cylinder and a pawl driven thereby for feeding clips to the clipping station;

FIG. 6 is a side elevational view taken along lines 6-6 of FIG. 5;

FIGS. 7-10 are enlarged elevational views of the clip feeding mechanism of FIG. 5 showing a cycle thereof for sequentially advancing clips to the clipping station;

FIG. 11 is an enlarged elevational view partially in section of the power tool and drive shaft attached thereto showing the internal operating mechanisms including a drive rod and a ram connected at its lower end;

FIG. 12 is an enlarged view of the drive shaft showing the drive rod extended and the ram driving a clip into the wood furniture rail;

FIG. 13 is a front elevational view of the machine of FIG. 2 showing a furniture rail being advanced through the clipping station;

FIG. 14 is an enlarged front elevational view of the wood rail engaging the clip sensor with pivoting of the clip sensor shown in phantom lines;

FIGS. 15-17 are various views of a level adjust mechanism for changing the distance between the power tool and the support surface on which the furniture rail is guided;

FIGS. 18-22 are various views of an adjustment mount assembly for the clip sensor to allow adjustments thereof in two transverse directions;

FIGS. 23 and 24 are views of a lock member utilized for fixing the clip sensor in one of the adjusted directions;

FIGS. 25-27 are various views of the pawl of the feeding mechanism;

FIGS. 28-31 are various views of a pronged furniture anchor clip that can be applied to furniture rails with the present machine;

FIGS. 32-35 are various views of a pronged furniture anchor clip that can be applied with some slight modifications to the present machine;

FIGS. 37-39 are various views of the ram adapted for driving the clip of FIGS. 28-31;

FIGS. 40-45 are various views of another ram that is adapted for driving the clip of FIGS. 32-35; and

FIG. 46 is a chart showing test results for ten runs taken at four different air supply pressures and the measured speed and energy obtained by the preferred rail gun power tool adapted for use with the present machine.

### DETAILED DESCRIPTION OF THE PREFERRED EMBODIMENTS

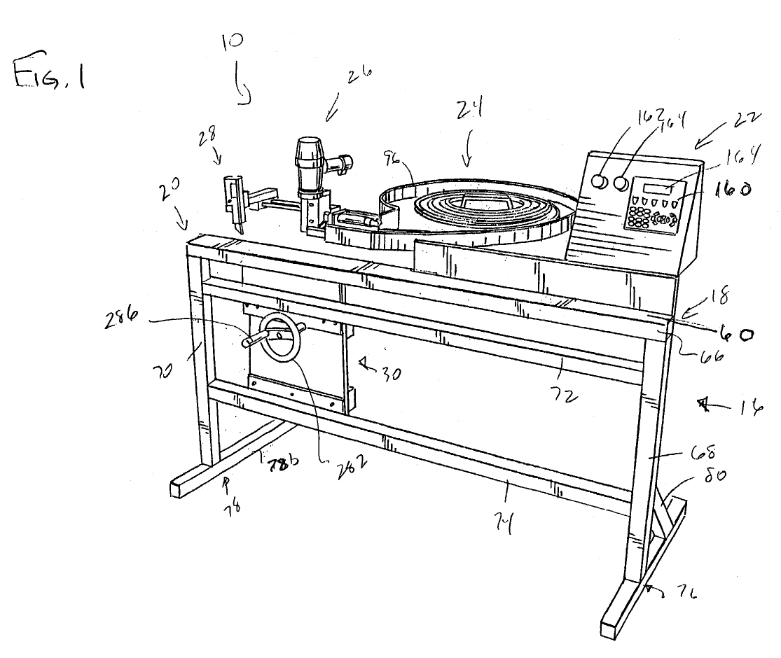

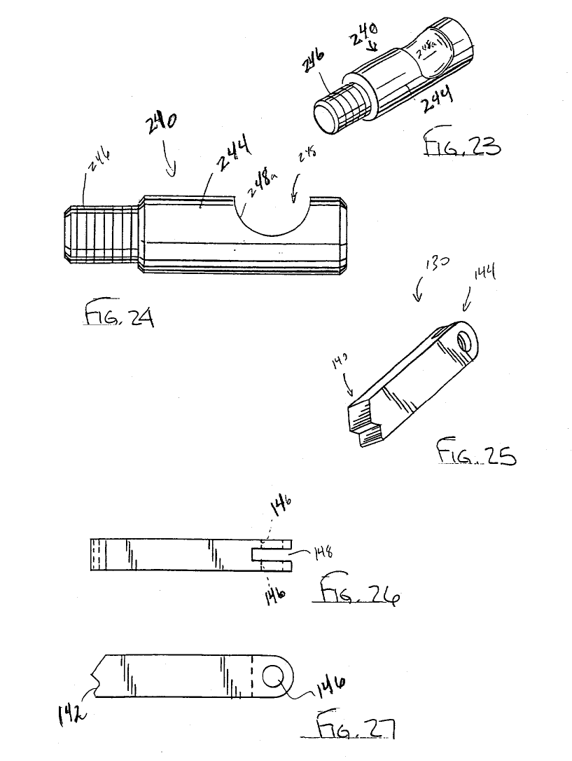

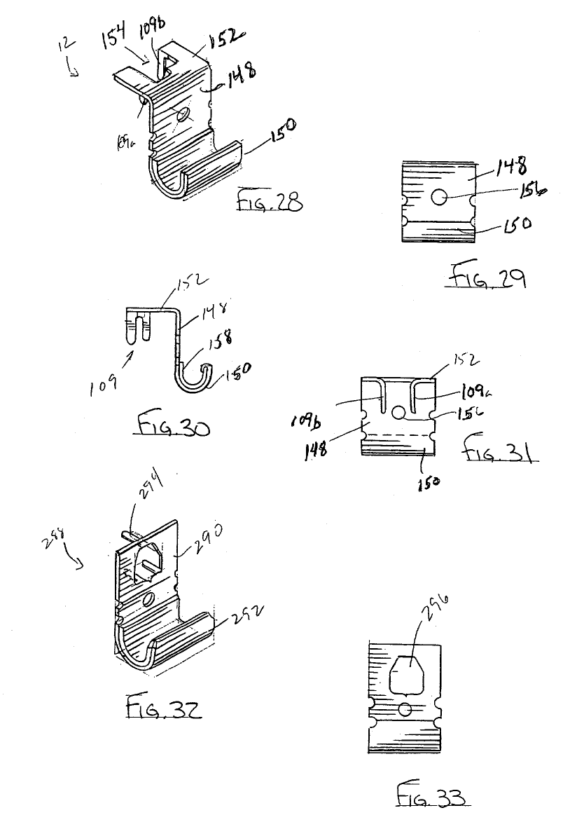

In FIGS. 1-3, an apparatus 10 is shown for applying furniture clips 12 (FIGS. 28-31) onto wooden frame parts for furniture such as wooden furniture rails in a high speed manner. The apparatus 10 herein in the form of the illustrated semi-automatic clipping machine provides significant flexibility in the type and/or configuration of furniture rails 14 that can be clipped therewith. The clipping machine 10 also is significantly simplified in its construction and operation so as to improve the reliability of its operation and reduce maintenance costs associated therewith.

As shown, the clipping machine 10 has a frame assembly 16 to which are mounted in order from the upstream end 18 of the machine 10 to the downstream end 20 thereof, a control panel box assembly 22, a tray assembly 24, a clipping station 26, and a clip sensing assembly 28. As will be described more fully hereinafter, it is preferred that the machine 10 herein include a level adjust mechanism 30 that raises and lowers each of the tray assembly 24, clipping station 26, and clip sensing assembly 28 together to allow the machine 10 to process furniture rails of varying thicknesses without the need for shims and the like utilized in some prior machines to raise rails of thinner stock to the necessary level for clipping with their fixed operator tools at the clipping stations thereof.

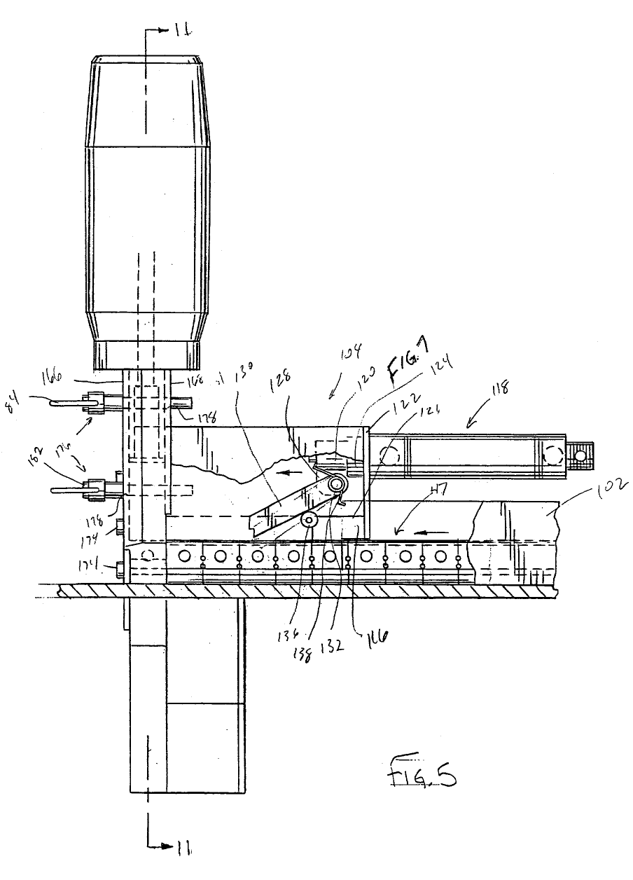

At the clipping station 26, the present machine 10 preferably has a power operator tool 32 that has been taken from a commercial pneumatic nail gun such as the finish nailer model N59FN provided by Stanley-Bostitch® of East Greenwich, R.I. The lower end of the Stanley-Bostitch® nail gun tool 32 has been modified with a drive shaft 34 for a ram 36 that is guided for reciprocation in the shaft 34. The ram 36 is shown best in FIGS. 37-39 and is of a lightweight construction for high-speed reciprocation thereof and adapted for engagement with the clips 12, as will be described more fully herein. As can be seen, the power tool 32 includes only a single drive rod 38 actuated by pressurized air whose supply is governed by a remote operating valve 40 schematically shown in FIG. 11, such as the control valve model number TVA4 provided by Stanley-Bostitch®. The air supply lines can be connected to the end of the handle portion 32a of the tool 32.

The operating valve 40 is actuated by the clip sensing assembly 28 for supplying high-pressure air into the tool housing 42 to drive the rod 38 for high-speed reciprocation therein (see FIG. 46 for test results showing speed and energy developed with various supply air pressures). For example, for the advance and retract strokes of the rod 38, the operating valve 40 can supply 80 psi air into the tool 32 with the pressurized air acting on the appropriate side of the piston 34 threaded to the rear end 46 of the drive rod 38 via porting formed in the housing 42. This causes the drive rod to move with an average speed of approximately 1180 inches per second, recognizing that attachment of the ram 36 will cause some slowing of this rate of travel. Although it is not anticipated that such cycling speeds can be utilized with the illustrated semi-automatic clipping machine 10 where an operator pusher the rails 14 downstream through the clipping station 26, the power tool 32 herein is capable of being fired thirty times per second. This is in sharp contrast to the prior power operator tool which has a maximum cycle rate of three advance and retract cycles per second.

In this regard, the present tool 32 utilizes its high-speed operation to achieve the breakage force necessary to separate the clip 12 from its collated string 47 in contrast to the breakage force developed with the mechanical advantage provided by the toggle link of the prior tool. Further, the use of a single drive rod 38 improves the reliability of the present tool 32 as it avoids all the pivot connections, and reduces the number of moving parts and thus avoids the pivoting action that occurred with the operating components of the prior tool. The clip string 47 is preferably collated in much the same manner as shown in U.S. Pat. No. 4,189,523 to Pearson, which is incorporated by reference as if reproduced in its entirety herein.

Another advantage the increased operating speed of the present operating tool 32 provides is that it will allow for hand-held use of the tool 32 for applying clips 12 to rails 14, without the need to employ extra bulky fixturing for rigidly holding the rails 14 fixed during clipping operations as otherwise would be required with the slower acting prior toggle link driven tool head, as previously described. In other words, because the prior tool employed a lever arm approach via the toggle link to push the slower moving ram and press the clip driven thereby into the rail, the rail needed to be rigidly held by the back-up rail in the machine and precisely positioned between this rail and the tool head during these slower clipping operations for proper clip application to the rail. In contrast, with the faster moving ram 36 herein, such precision and rigidity are not as important since the high speed driving of the clips 12 by the linearly actuated drive rod 38 of the fastener tool 32 generates the necessary energy and force for driving the clips 12 into the rails 14, akin to how the tool 32 would operate for driving fasteners as a hand-held finish nailer gun. Since the driven clips 12 will have very high speeds and energy levels exiting the tool head 32 and shaft 34 thereof, they will more likely still be able to pierce into the rails 14 and properly be seated thereagainst despite some slight variations in the position of the tool 32 relative to the rail 34 from one clipping operation to the next and despite having a less than rigidly held rail 14 into which they are being applied, such as commonly are the conditions with use of handheld tools. While optimum results would be obtained from having rigid fixturing for the rail 14 with consistent position of the tool 32 relative thereto such as in the machine 10, such is not necessary enabling the tool 32 to have a relatively compact and light weight construction to allow for the provision of an ergonomic hand-held version thereof.

The present machine 10 in addition to being improved in terms of its reliability also is designed such that it has increased flexibility in allowing rails 14 to be clipped therewith that are not of the traditional sizes and shapes such as those having non-linear configurations with offset or curved portions thereof. For this purpose, the clip sensing assembly 28 includes an adjustment mount, generally designated 48, that allows for shifting of the clip sensing assembly 28 to a wide variety of different positions beyond those just in the longitudinal direction 50 of travel of a linear portion of a wood furniture rail 14 through the clipping station 26. In this regard, the present adjustment mount 48 includes a guide assembly 52 that allows for adjustment of the clip sensing assembly 28 in the longitudinal direction 50, and a guide assembly 54 that allows for adjustments of the clip sensing assembly 28 in transverse direction 56 substantially normal to the longitudinal direction 50 such that compound movements of the sensing assembly 28 can be achieved to vary the position thereof relative to the clipping station 26 downstream therefrom in the direction 50 as well as inward and outward relative to the front 58 of the machine 10 in the normal or transverse direction 56.

Further, the adjustment mount 48 including the guide assemblies 52 and 54 thereof are mounted such that the operating components are spaced from, and preferably well over and above a substantially horizontal guide surface 60 of the machine frame assembly 16 on which the furniture rails 14 ride as they are being advanced downstream through the clipping station 26. In this fashion, the offset or curved portions of the rails 14 can be fit into a clearance area 61 downstream of and behind the clipping station 26 without interference from the adjustment mount 48 for the clip sensing assembly 28. Also, the clip sensing assembly 28 includes a pneumatic cylinder 62 that is generally vertically oriented and which includes a depending clip engaging member 64 which it drives for advancing and retracting movements thereof. If one wishes to apply clips 12 to a linear portion 14b of a furniture rail 14 having an offset portion 14a (see FIG. 1b), the clip engaging member 64 can be started in the retracted position to allow the rail offset portion 14a to fit in the area 61 thereunder. Once the offset portion clears the area 61, the clip engaging member 64 can be advanced for engaging the first applied clip 12 on the rail linear portion 14b to be clipped and for subsequent application of the clips 12 to the linear portion in a sequential manner.

Several other of the advantages of the present machine 10 in addition to those just described will become readily apparent from the more detailed description provided thereof as set forth hereinbelow. As previously mentioned, the frame assembly 16 includes a substantially horizontally extending support surface 60 on which the wood furniture rail 14 can ride as it is advanced through the clipping station 26. As can be seen in FIGS. 1-5, the guide surface 60 is formed on a horizontal plate member 65 secured on longitudinally extending frame member 66 that is attached as by welding at the upper ends of vertical frame members 68 and 70 at the upstream and downstream ends 18 and 20 of the machine 10.

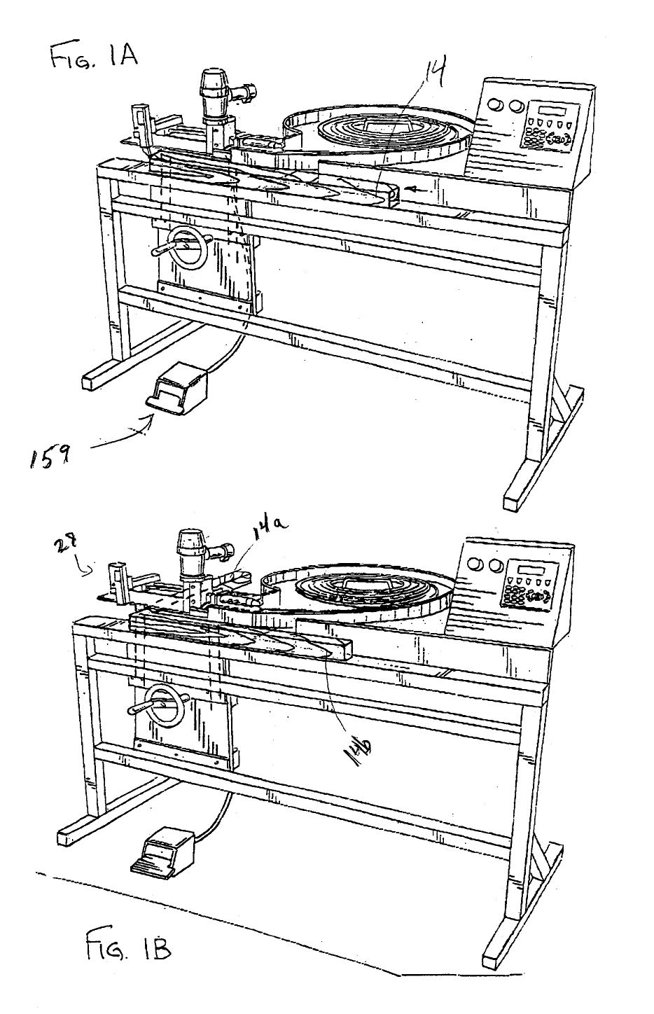

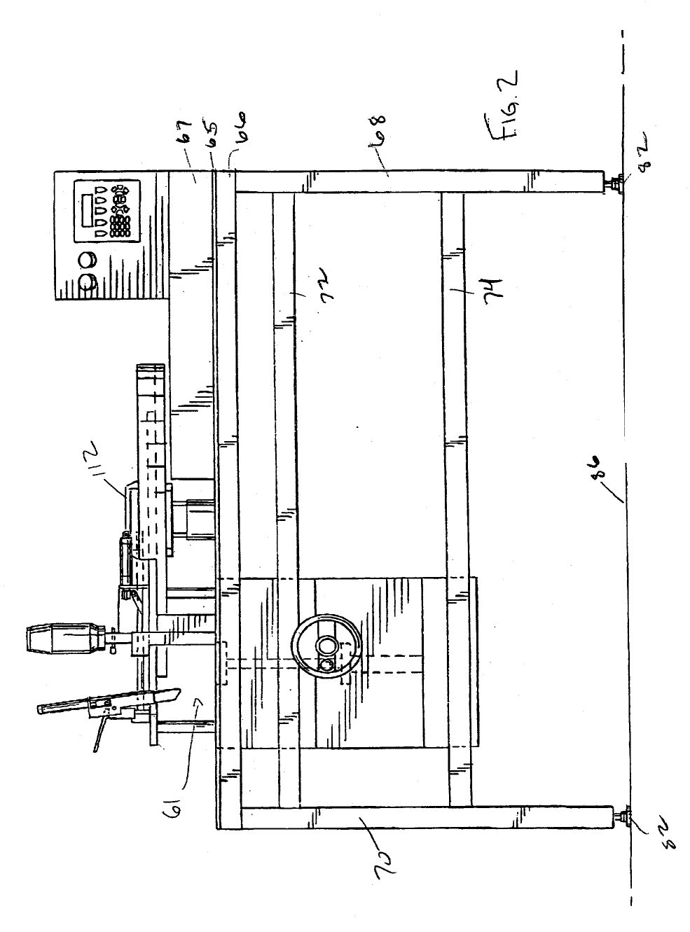

A vertical guide fence or plate 67 extends longitudinally in the downstream direction 50 upstanding from the rear of the support plate 65. The fence 67 extends from the upstream end 18 of the machine 10 and stops upstream of the clipping station 26, as best seen in FIGS. 1 and 2. Intermediate and lower longitudinally extending frame members 72 and 74 also extend between the members 68 and 70. Each of the longitudinal members 66, 72 and 74 extend parallel to each other and in the downstream direction 50. At the lower ends of the vertical member 68 and 70 are respective horizontal transversely extending members 76 and 78, that generally extend parallel to each other and in the normal direction 56. As can be seen in FIGS. 1 and 4, the lower members 76 and 78 have portions 76a and 78a that extend forwardly a short distance beyond the respective vertical members 68 and 70 and portions 76b and 78b that extend rearwardly beyond these members a greater distance. To provide extra support between the vertical members 68 and 70 and rearward extending portions 76b and 78b of the associated lower horizontal members 76 and 78, struts 80 extend at an angle therebetween. At the bottom of the lower horizontal members 76 and 78 are a pair of adjustment feet 82 and 84 forwardly and rearwardly of the vertical members 68 and 70. These feet 82 and 84 provide screw adjustments to allow for leveling of the machine 10 to accommodate for potential irregularities or inclines in the floor surface 86 on which they are engaged.

90Preferably, all of the frame assembly members are of tubular extruded metal material and together form a frame primary portion that is of a robust, unitary construction and takes up a minimum of floor space. In this manner, the present machine 10 is provided with a compact form which, in addition to conserving floor space, saves on the shipping space necessary for transportation from the machine manufacturer to its final installation destination and the expense associated therewith.

Continuing reference to FIG. 4, there it can be seen that the tray assembly 24 is secured to an arm mount 88 removably attached to a vertically adjustable table member 268 of the level adjust mechanism 30 described hereinafter and extending rearwardly from the front 58 of the machine 10. The tray assembly 24 includes a pan portion 90 that is attached to distal end 92 of the arm 88 via central upstanding members, generally designated 94. The pan portion 90 includes a flat bottom surface 95 and a short, annular wall 96 projecting vertically upward at the outer edge of the surface 95 with the wall 96 extending for close to 360° but for a forward portion thereof which forms an opening 98. At the opening 98, wall portions 100 and 102 are provided on either side thereof to form an area therebetween in which the collated string 47 of clips 12 extends toward the clipping station 26 on the pan bottom 95, and specifically to a clip feed mechanism 104 immediately upstream therefrom.

In addition to the pan portion 90, the tray assembly 24 also includes a removable platter portion 106 on which the coils of the collated clip string 47 are supported. The platter portion 106 has a substantially flat circular shape with a main flat plate portion 108 sized to fit in the pan portion 90 with its periphery closely bounded by the upstanding outer wall 96. In this manner, the outer coils of the collated clip string 47 are constrained from falling off the outer periphery of the platter portion 106 as the outer coil is drawn off the platter portion 106 for feeding the clips 12 to the clipping station 26. As the clips 12 are of a metal material and include sharp edges and corners as well as prongs 109 (FIG. 30), the tray assembly 24 including the pan portion 90 provides a significant safety benefit in avoiding hanging or drooping portions of the clip string 47.

For coiling of the clip string 47 on the platter portion 106, a central hub portion 110 is raised from the flat plate portion 108. Accordingly, the innermost coil is wrapped tightly around the hub portion 110 with the remaining coils radiating out therefrom, as best seen in FIG. 3. The platter portion 106 can easily be removed from or placed in the pan portion 90 via the provision of a handle 112. A central hole 114 in the hub portion 110 allows for the platter portion 106 to be guided and centered in the pan portion 90 as it is placed therein via the uppermost member 94 extending upwardly from the arm mount 88. Thus, for shipping of the machine 10, the control panel 22, the clipping station 26, clip sensing assembly 28 and the clip feed mechanism 104 can all be attached to the frame assembly 16 with the tray assembly 24 detached therefrom via removal of the arm mount 88 from the frame assembly 16.

The clip feed mechanism 104 will next be described. The collated clip string 47 is taken off the platter portion 106 so as to freely extend between the pan wall portions 100 and 102 as it is led into cassette housing 116 of the clip feed mechanism 104. The cassette housing 116 extends from the pan portion 90 to the lower end of the drive shaft 34 with the clips 12 loosely extending through the housing 116 and only the leading clip 12a being substantially constrained against shifting in the shaft 34, as best seen in FIG. 11. Accordingly, the clip string 47 does not ride on a vertical rail or the like as in prior semi-automatic machines further simplifying the construction of the present machine 10. It has been found that the collation of the clips 12 in the string 47 as well as confining the leading clip 12a in the drive shaft 34 and having the clip feeding mechanism 104 engage the clip string 47 with the leading clip 12a still attached to the string 47 is sufficient to maintain the clips 12 in proper orientation for clipping operations, as will be described herein.

The clip feed mechanism 104 includes a linear actuator in the form of an air cylinder 118 having a plunger 120 with advance and retract strokes in the longitudinal direction 150 which is the same direction that the clips 12 are advanced into the tool drive shaft 34, for simplification of the operation of the present clip feed mechanism 104 over the previously described prior feed mechanism. The cylinder 118 is mounted to a transverse wall 122 via a nut 124 screwed tightly against the backside of the wall 122. The transverse wall 122 extends upwardly from upper wall 126 of the housing 116.

At its distal end, the plunger 120 has a downwardly facing yoke 128 secured thereto. A clip engaging member in the form of a pawl 130 is attached to the yolk 128 via a pivot pin 132 so that the pawl 130 can pivot relative to the yolk 128 and attached piston rod 120. An elongate slot 134 is formed in the housing upper wall 126 and extends in the direction 50 for allowing the pawl 132 to project therein and engage the clips 12 collated in the clip string 47. A cam in the form of a roller bearing 136 is fixed, preferably at the upstream end of the slot 130 for lifting the pawl 130 out of engagement with the clips 12. A torsion spring 138 is coiled about the pin 132 for biasing the pawl 130 through the slot 134 and into engagement with one of the clips 12 in the string 47.

Referring to FIGS. 25-27, the pawl 130 has an engagement end 140 having a notch 142 formed therein. At the other end 144, the pawl 130 has a split construction with aligned through holes 146 through which the pin 132 can extend 144. Accordingly, a gap 148 is formed at the pawl end 144 to expose the pivot pin 132 therein and allowing the torsion spring 138 to be coiled about the pin 132 in the pawl gap 148.

Referring next to FIGS. 28-31, the clips 12 herein are of the same general construction disclosed in U.S. Pat. No. 4,102,586 as well as the previously mentioned '523 patent. Accordingly, the clips 12 include a flat base portion 148 provided with a reverse bend or a hook portion 150 in which a portion of a furniture spring can be received. The other end of the base portion 148 has a downturned leg portion 152 generally at a right angle to the base portion 148 so as to seat at a corner of the furniture rail to which it is applied. For this purpose, the leg portion 152 has a pair of prongs 109a and 109b formed therefrom which are driven into the wood of the rail 14. An opening 154 having a generally L-shaped configuration is formed in the leg portion 152, in part, due to the bending of the prongs 109a and 109b therefrom. An indexing aperture 156 is formed through the base portion 148. For avoiding metal-to-metal contact with the spring portion received in the clip hook portion 150, a liner 158 such as of plastic material can be attached therein by a wide variety of means.

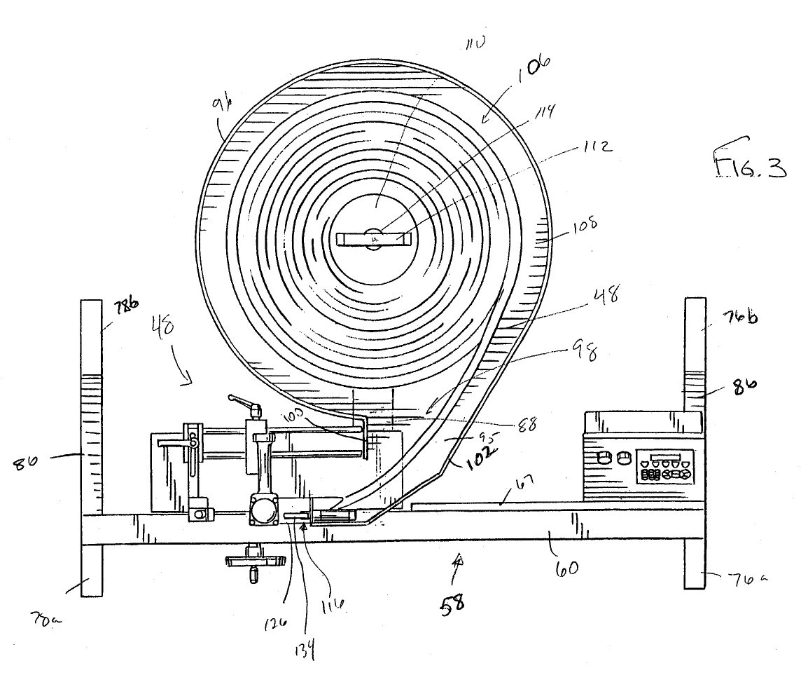

The clips 12 are coiled such that when they enter the cassette housing 116, the clip base portion 148 is vertically oriented with the leg portion 152 being raised and extending forwardly therefrom and the hook portion 150 extending rearwardly and running on the bottom 159 of the housing 116, as best seen in FIG. 6. In this manner, the clip opening 154 is facing upwardly and in the alignment with the housing slot 134 such that when the pawl 130 is pivoted into the housing 116, its notched end 140 will engage in the clip opening 154. More specifically, the notch 142 can form a right angle surface that engages substantially flush against the corresponding right angle surface formed on the clip 12 by the clip leg portion 152 and the depending prong 109b, as can be seen in FIGS. 8-10.

Continuing reference to FIGS. 8-10 along with FIG. 7 to describe operation of the clip feed mechanism 104, to start when the ram 36 is retracted in the shaft 34, the cylinder 118 will be in its retracted condition. In this position, the plunger 120 has pulled the retractor 130 upstream in the direction 50. As shown in FIG. 7, the cam roller 136 engages the pawl 130 so as to lift it out from engagement with the clips 12 against the bias afforded thereto by the torsion spring 138. When the machine 10 clipping operations are first started as by foot pedal 159, the cylinder 118 can be fired to cause the plunger 130 to advance downstream in the direction 50 so that the pawl 130 disengages from the cam roller 136, as shown in FIG. 8. Alternatively, the pawl 130 can be pulled manually and placed into engagement with the clips 12 with the leading clip 12a in the drive shaft 34 and the foot pedal 159 operable to fire the tool 32.

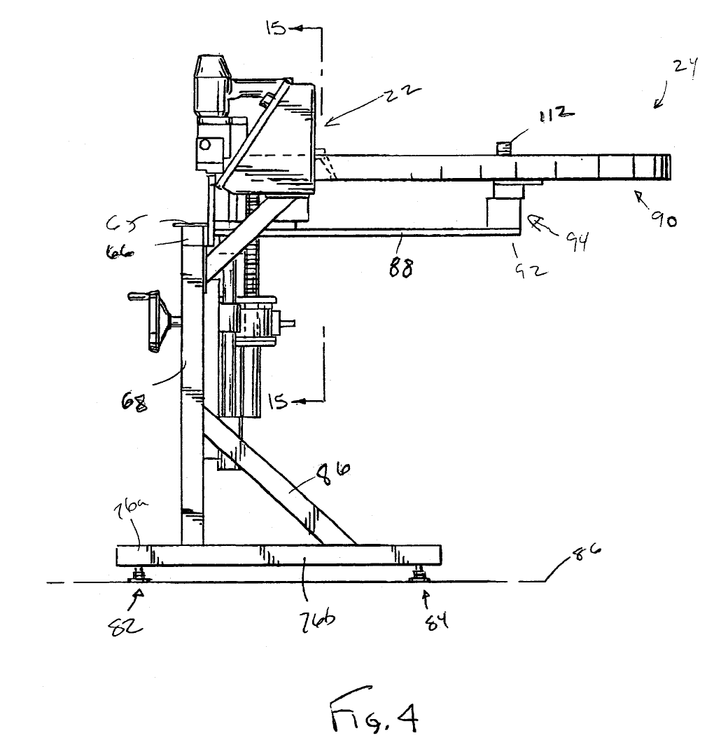

Once the pawl 130 is shifted sufficiently downstream to separate from the cam roller 136, the spring bias on the pawl 130 causes it to pivot its engagement end 140 downwardly for registering in an opening 154 in one of the clips 12, as previously described. Continued extension of the cylinder plunger 130 is shown in FIG. 9 such that with the pawl 130 engaged in one of the clips 12, the clip string 47 is advanced through the cassette housing 116 with the leading clip 12 entering the lower end of the drive shaft 34.

The power tool 32 is actuated for its downward driving stroke at the same time or shortly after the firing of the cylinder 118 so that the ram 36 will not reach the lower end of the drive shaft 34 prior to entry of the leading clip 12a into a clipping position therein. Generally, this will not be a concern during ongoing clipping operations, as the pawl 130 will be pushing a clip 12 against the extended ram 36 so that the clip 12 will immediately enter the shaft 34 once the ram 36 clears the shaft lower end via retraction thereof. The timing of the firing of the tool 32 and the cylinder 118 can be coordinated via a programmable logic controller (PLC), a control panel 160 of which is shown at the control panel box assembly 22.

As the ram 36 is breaking the leading clip 12a off from the string 47 for driving it into the wood rail 14, the cylinder 118 can be retracting the rod 120, as shown in FIG. 10. Once the plunger rod 120 reaches full retraction, the pawl 130 will have engaged the edge of the opening 154 adjacent the prong 109a so that it is pulled and runs along the leg portions 152 of the clips 12 in the string 47 until lifted off therefrom by engagement with the cam roller 136. In this manner, when the cylinder 118 is fired again, the pawl 130 will not be pushed significantly on the clip legs 152 before it registers in one of the openings 154 thereof thus minimizing the chance that the pawl 130 will get caught or hung up before properly engaging one of the clips 12.

After the initial clip 12a is applied to the wood rail 14, subsequent clipping operations will be initiated by actuation of the clip sensing assembly 28, as will be described more fully herein. The power tool 32 and cylinder 118 are then timed via the PLC such that with the ram 36 in the driving position of FIGS. 10 and 12, the cylinder 118 will be actuated so that the next forwardmost clip 12b is being pushed against the side of the ram 36, as previously mentioned. The ram 36 is then retracted up and once it clears the lower end of the drive shaft 34, the pawl 130 will push the clip 12b into the shaft 34 ready to be driven into the rail. Thereafter, the cylinder 118 is retracted and the cycle proceeds as previously described with successive clipping operations actuated by the clip sensing assembly 28.

Besides providing timing control for the operating assemblies of the present machine 10, the PLC via the panel interface 160 can also provide security so that only authorized personnel can operate the machine 10. Accordingly, an operator must enter a password via the control panel 160 that the controller recognizes before it allows them to power up the machine 10 as by power switch 162 on the box assembly 22. The control panel 160 also allows an operator to set the clip engaging member 64 of the sensing assembly 28 in either its advanced or retracted state prior to the start of clipping operations such as can be necessary for those furniture rail pieces 14 having offset portions 14a, as shown in FIG. 1b and as previously discussed herein. Further, the control panel 160 allows for predetermined settings for the sensor assembly 28 associated with different kinds of parts to be stored in memory so that the setting can be accessed and utilized by an operator to improve their efficiencies in using the machine 10. The control panel 160 can have an LCD display 164 for showing an operator various parameters including those relating to the variable set-up discussed above, clip time (e.g., 0.10 sec.), active time (e.g., 10.0 secs.), and clip stop-up status which is the clip engaging member 64 of the sensing assembly 28,(e.g., yes or no). The box assembly 22 can also include an emergency stop button 164 for shutting off power to the machine 10 in emergency situations for safety purposes.

As previously discussed, the power tool 32 is a commercial nail gun that is slightly modified for use with the present machine 10 via the drive shaft 34 for the ram 36 which is of special construction for driving furniture clips 12 into wood furniture rails 14. The drive shaft 34 depends from the lower end of the housing 42, as can be seen in FIGS. 5 and 11. The shaft 34 includes a pair of side plates 166 and 168 and a front wall 170 extending therebetween. A rear block member 172 completes the drive shaft as the side plates 166 and 168 extend between the front wall and are secured to the block 172 via fasteners 174. The rear block member 172 can be extended beyond its use as the rearwall of the drive shaft 34 to support other components of the machine 10, such as the sensor assembly 28 as described hereinafter. Manifestly, to adapt the operating tool 32 for hand-held use, the shaft 34 and particularly the rear wall thereof as formed by the block member 172 need not be as large so that the shaft 34 can be minimized in terms of its size and weight.

The front wall 170 is detachably connected to the side plates 166 and 168 via a quick-release attachment provided by pull pin devices 176. These pin devices 176 extend through aligned apertures 178 in the side plates 166 and 168 and apertures 180 in the front wall 170. The pin devices 176 include a central biased pin member 182 that when depressed allows the pin devices 176 to be withdrawn from the apertures 178 and 180 via pull rings 184. With the front wall 170 removed, ready access to the ram 36 in the shaft 34 is provided for maintenance and/or replacement thereof, if necessary.

The inner surfaces of the side plates 166 and 168, the front wall 170 and the rear block 172 in the drive shaft 34 cooperate to provide guide surfaces for the ram 36 along the front 186, rear 188, and opposite sides 190 and 192 thereof. The sizing between the front 186 and rear 188 of the ram 36 closely approximates the distance between the distal end of the clip leg portion 152 and the tip of the hook portion 150. The side plate 168 of the drive shaft 34 stops well short of the lower end of the front wall 170 of the shaft 34 so that the clips 12 have an opening 194 (FIG. 11) in which they can be advanced into the lower end of the shaft 34 via the clip feed mechanism 104 with the free or unattached side of the clip 12a engaged against the opposite side plate 166 that extends substantially the full length of the shaft 34 in which the ram 36 is driven. Accordingly, the inner shaft surfaces of the front wall 170, rear block 172 and side plate 166 along with the collated attachment of the clip 12a to the clip string 47 keeps the clip 12a in its proper orientation to be engaged by the ram 36 for being driven into the furniture rail 14.

The ram 36 has a cut out area 196 that is provided with special surface features for engaging the clip 12, as best seen in FIG. 39. More particularly, on the upper horizontal surface 198 of the cut-out area 196 are a pair of projections 200 and 202 which cooperate to define a raised portion from the surface 198 having a generally L-shaped configuration substantially matching that of the opening 154 and in alignment therewith. A projection 204 extends downwardly from the surface 198 on one side of the ram 36 to provide a vertical clip engaging surface 206 thereon that is at a right angle to the horizontal surface 198. Thus, when the tool 32 is fired, the ram 36 travels downwardly as the piston rod 38 is extended and into engagement with the clip 12a with the projections 200 and 202 registering in the clip opening 154 and the ram surfaces 198 and 206 engaging the clip leg portion 152 and base portion 148, respectively, for driving of the clip 12a straight downwardly such that the clip prongs 109 fully embed themselves in the wood furniture rail 14 with the clip base and leg portions flush against the corner of the rail 14, as shown in FIG. 12.

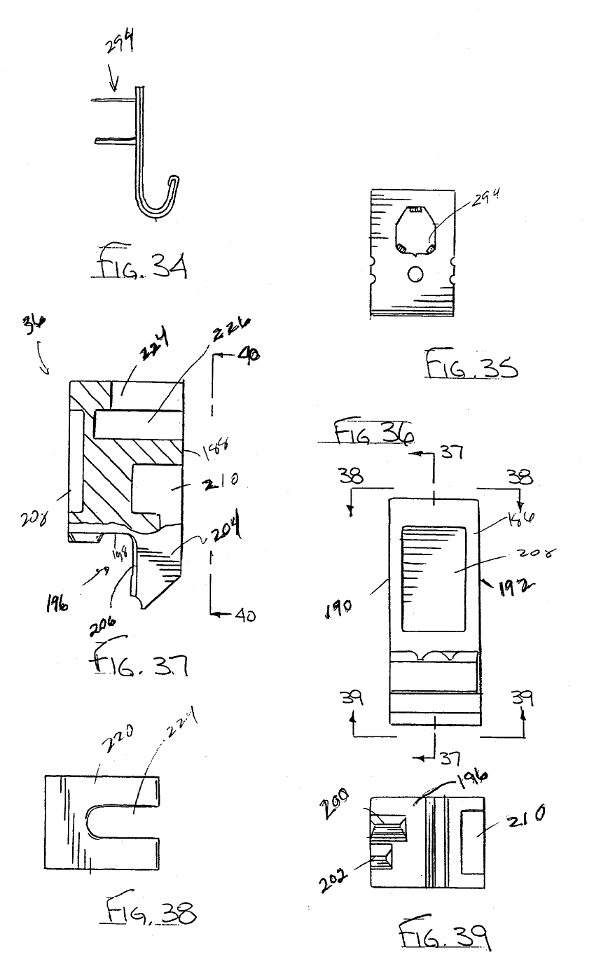

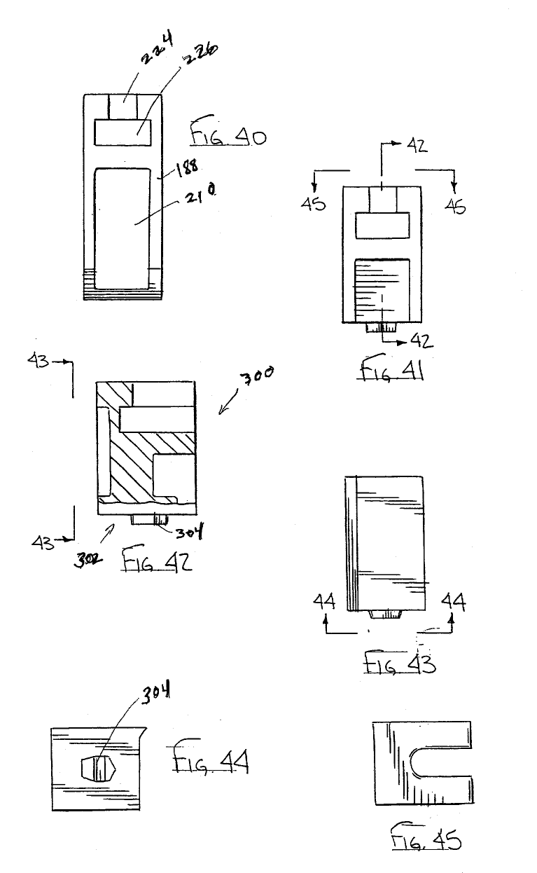

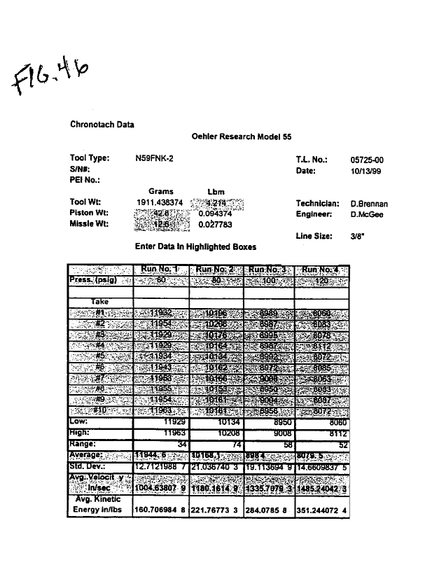

As can be seen in FIGS. 37-40, the ram 36 has weight reliefs 208 and 210 formed in the front 186 and rear 188 thereof. In this manner, the weight of the ram 36 does not significantly slow the speed of the drive rod 38 as generated by the high speed operation of the power tool 32.

The piston drive rod 38 is adapted at its lower end 212 projecting beyond lower cap member 214 of the tool housing 42 for a slide fit with the ram 36. More particularly, the drive rod 38 has upper and lower enlarged annular portions 216 and 218 with a reduced neck portion 220 extending therebetween at the lower end 212 thereof.

The ram 36 is slotted at the top 222 thereof with an upper narrow slot 224 and an immediately lower wider slot 226 both opening to the rear 188 of the ram. To put the ram 36 onto the end 212 of the drive rod 38, the front wall 170 of the drive shaft 34 is removed and the ram 36 is slid onto the drive shaft end 212 such that the narrow neck portion is fit in the slot 224 with the lower enlarged annular portion 218 in the slot 226, as can be seen in FIGS. 11 and 12. The sizing of the neck portion 220 is such that upper enlarged annular portion 216 will be closely adjacent the top 220 of the ram 36 so as to capture the ram 36 at the top 220 thereof between the enlarged portions 216 and 218 on the end 212 of the drive rod 38. To remove the ram 36 from the shaft 34, one merely reverses the operation described above, removing the shaft front wall 170, as previously described, and sliding the ram 36 off of the drive rod end 212.

Returning to the description of the clip sensor assembly 28, the sensor assembly 28 is mounted to the frame assembly 16 via the plate mount 224 attached at the rear of the block member 172. The plate mount 224 has an upper enlarged portion 226 such that it has an inverted L-shaped configuration with the enlarged portion 226 having a pair of through holes 228 formed therein. Horizontally extending guide rods 230 extend through the holes 228 and can be slid therein and locked in position once the desired longitudinal position of the clip engaging member 64 has been achieved.

For this purpose, the guide assembly 52 includes a fast acting lock mechanism 232 that locks one of the guide rods 230 in a rigid fixed position in its associated through hole 228. Since the guide rods 230 are tied together at their downstream end via a bearing block 234 of the transverse guide assembly 54, locking one of the rods 230 in its through hole 228, it is effective to prevent longitudinal movement of both of the guide rods 230 thus fixing the sensor assembly clip engaging member 64 in the desired longitudinal position.

The lock assembly 232 includes a handle 236 integral with an internally threaded base 238. A lock member 240 is mounted in a transverse bore 242 formed in the enlarged portion 226 of the plate mount 224 and which intersects one of the longitudinally extending through holes 228 formed therein. As shown in FIGS. 23 and 24, the lock member 240 includes a rod-engaging portion 244 having a reduced threaded nipple 246 at one end thereof and an arcuate cutout 248 adjacent the other end thereof. The cutout has a semicircular cross-sectional shape having a radius substantially the same as that of the through opening 228.

The threaded nipple 246 projects out from the bore 242 and is threaded to the internally threaded base 238 of the lock handle 236. For longitudinal adjustments of the clip sensing assembly 28, and particularly the clip engaging member 64 thereof, the handle 236 is rotated so that the lock member 240 is shifted in the bore 242 to bring the cutout 248 and specifically surface 248a thereof into substantial alignment with the hole opening 228. Once the clip engaging member 64 is in the desired longitudinal position, the handle 236 is rotated in a direction causing the lock member 240 to be pulled for shifting such as in an outward direction relative to the plate mount portion 226. This will cause the surface 248a of the cutout to engage against the guide rod 230 and pull it along therewith to provide a bending action on the rod 230 with the frictional engagement between the cutout surface 248, that is now slightly out of alignment with the through opening 228, and the rod 230 extending therethrough being sufficient to provide a very robust locking action on the guide rod 230 with minimal operator effort in turning of the lock handle 236. When the operator desires to once again adjust the longitudinal position of the clip engaging member 64, they simply turn the lock handle 236 in the opposite direction to shift the lock member 240 in the bore such that the surface 248 thereof is in alignment with the cylindrical wall about the hole opening 228 at which time the guide rod 230 can freely slide therein.

For adjustments in the transverse direction 56, a slide guide 250 is provided with a sliding or dovetail fit with the bearing block 234. At the front end of the slide guide 250, a small upstanding mounting block 252 is attached to which a cylinder support 254 is pivoted. Accordingly, inward and outward movements of the slide guide 250 in the transverse direction 56 will shift the cylinder 62 and clip engaging member 64 of the clip sensing assembly 28 therewith for transverse positioning thereof.

The slide guide 250 includes a slot 258 extending therethrough from the top to the bottom thereof. Lock assembly 258 for the transverse guide assembly 54 includes a vertical post 260 extending through the slot 256 and fixed at its lower end to the bearing block 234 with upper end 262 of the post 260 projecting above the slide guide 250 being threaded. A lock handle 264 is threaded to the post upper end 262 via an integral internally threaded base portion 266 thereof. To lock the sensor assembly 28 in a desired transverse position, an operator rotates the handle 264 until the base 266 bears tightly down against the top of the slide guide 250 thus clamping it to the bearing block 234. For adjusting the transverse direction 56 of the sensor clip sensing assembly 28, the handle is turned in an opposite direction for loosening the base portion off from the slide guide 250 to allow it to be slid in the bearing block 234 to the desired transverse position.

Once the proper position of the sensor assembly 28 has been set in both the longitudinal direction 50 as well as the transverse direction 56, if necessary, the furniture rail 14 can have clips 12 applied thereto with the position of the sensor assembly 28 setting the distance between adjacent clips on the rail 14. For this purpose, scales or the like can be mounted to the frame in the adjustment area of the clip sensing assembly 28 so that an operator can precisely gauge the distance between adjacent clips 12 to be applied to the furniture rail 14.

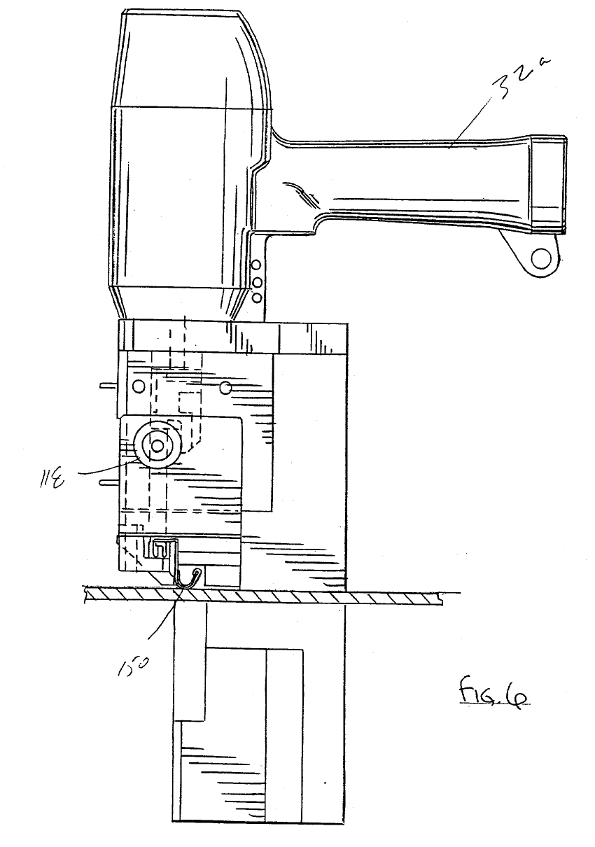

Referring to FIGS. 13 and 14, as the rail 14 is advance through the clipping station 26, an initial clip 12 will be applied thereto. The clip sensing assembly 28, and in particular the clip engaging member 64 thereof, are adjusted so that when the rail leaves the clipping station 26 with a clip thereon, the inner side of the rail 14 will clear the member 64 while the clip 12 therein will engage the member 64. As shown, the cylinder 62 including its support 264 are in a general vertical orientation however with a slight cant so that the projecting member 64 is inclined in the upstream direction. This cant can be provided by weighting of the support 254 appropriately relative to the pivot 256. When the applied clip 12 engages the member 64 the cylinder 62, support 254 and member 64 will pivot or rock in a clockwise direction, as can be seen in phantom lines in FIG. 14. A sensor such as a proximity sensor (not shown) can be mounted to the downstream side 268 of the support 254 such that once the engaging member 64 has pivoted sufficiently in the counterclockwise direction to be generally vertical aligned with the sensor, the sensor will detect the member 64 signaling the PLC to begin timed operation of the power tool 32, cylinder 62 and cylinder 118. In this regard, the power tool 32 and cylinder 62 can fire simultaneously so that as the next clip is being applied to the rail 14, the member 64 is being retracted by the cylinder 62 so that the rail can advance further downstream. As the member 64 is retracted into the support 254, the support 254 will start to rock back to its slightly upstream canted position and the cylinder 62 will then return the member 64 to its advanced, ready to be engaged position. At the same time the power tool 32 is undergoing its advancing stroke for engaging the leading clip 12a with the ram 36 for applying it to the wood rail and its retracting stroke so that the next clip 12 can be pushed into the drive shaft 34 via the clip feeding mechanism 118, as previously described. Accordingly, the PLC times the cylinder 118 to fire for its retracting stroke at a slight delay from the sensing of the already applied clip 12 by the sensing assembly 28.

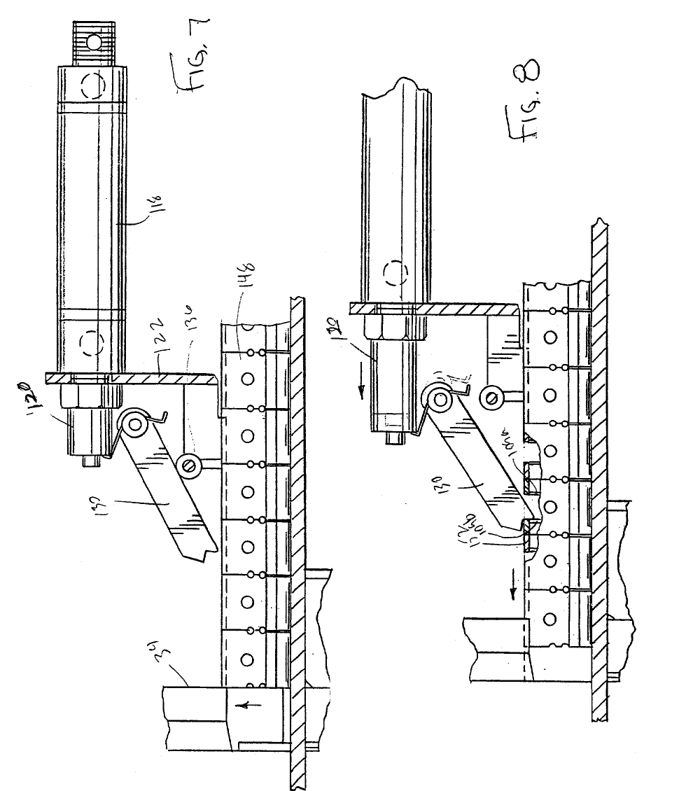

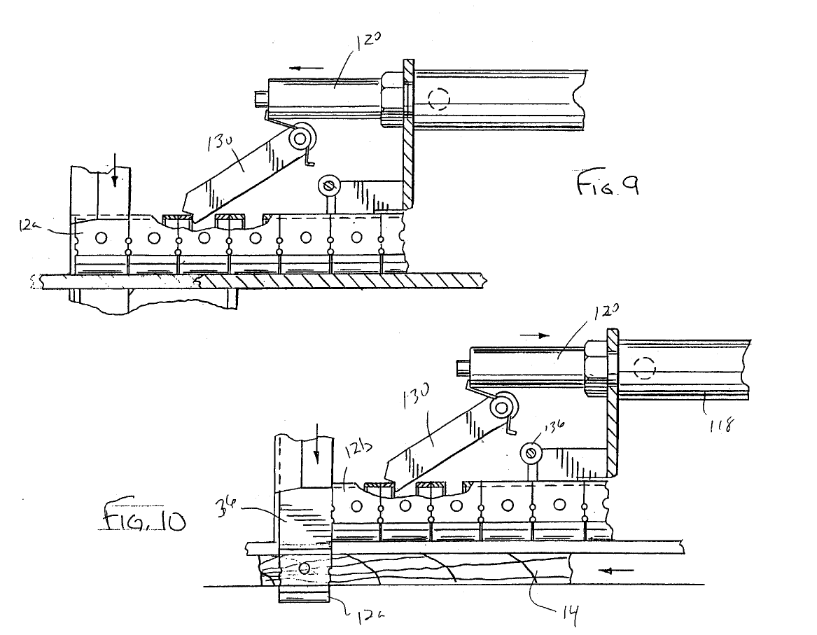

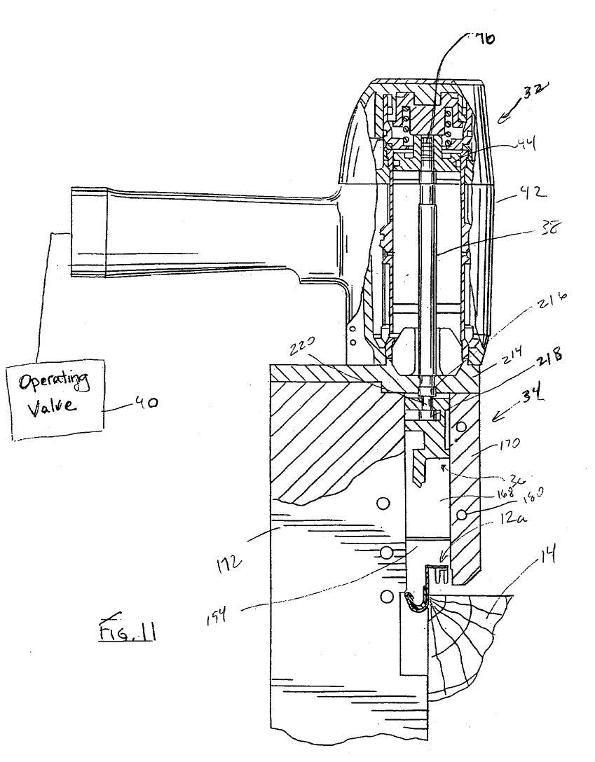

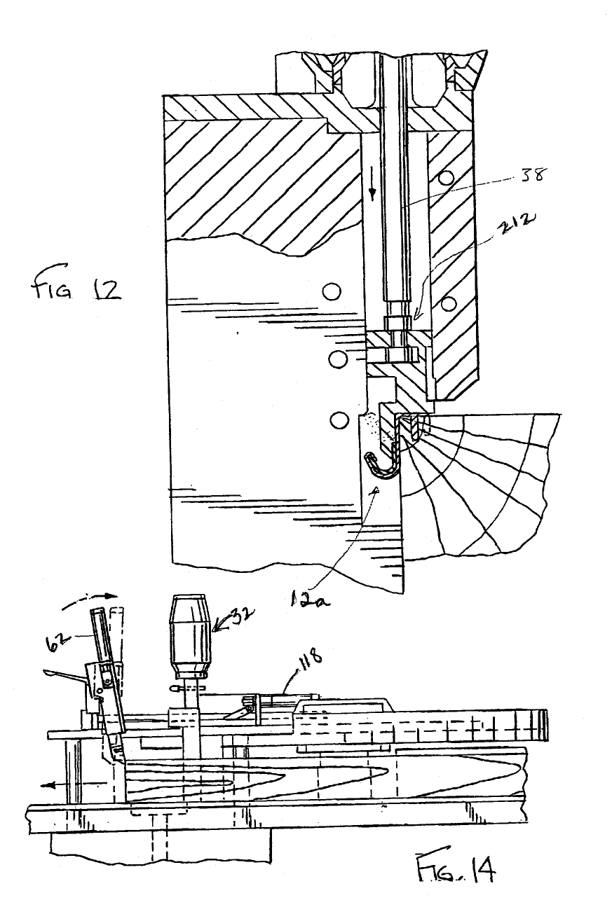

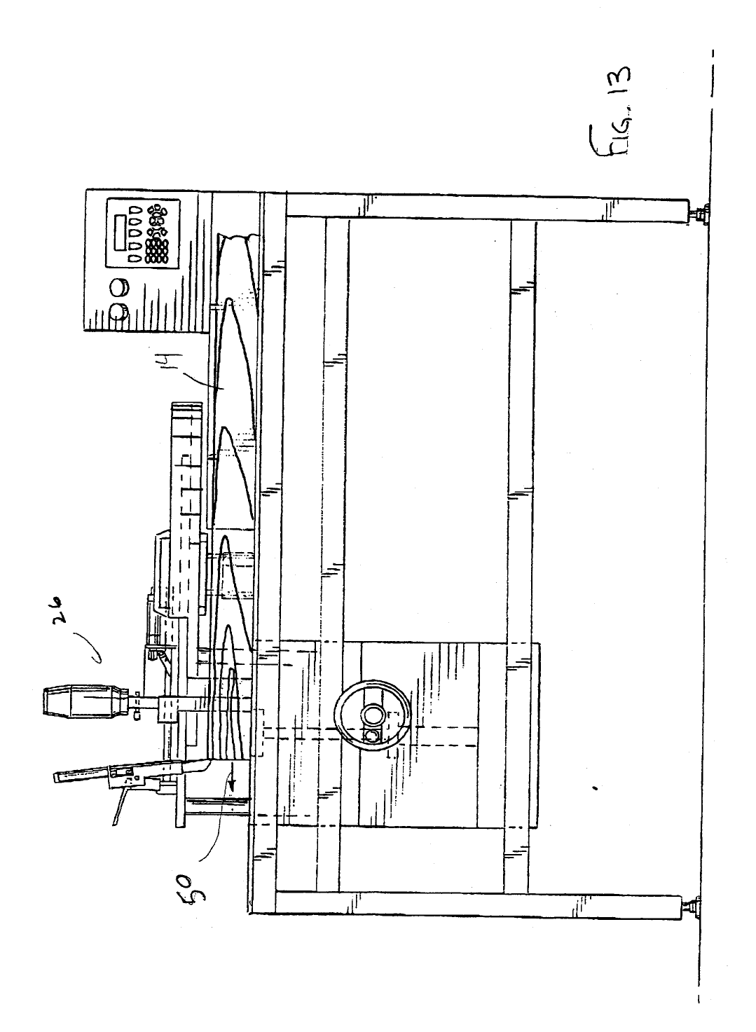

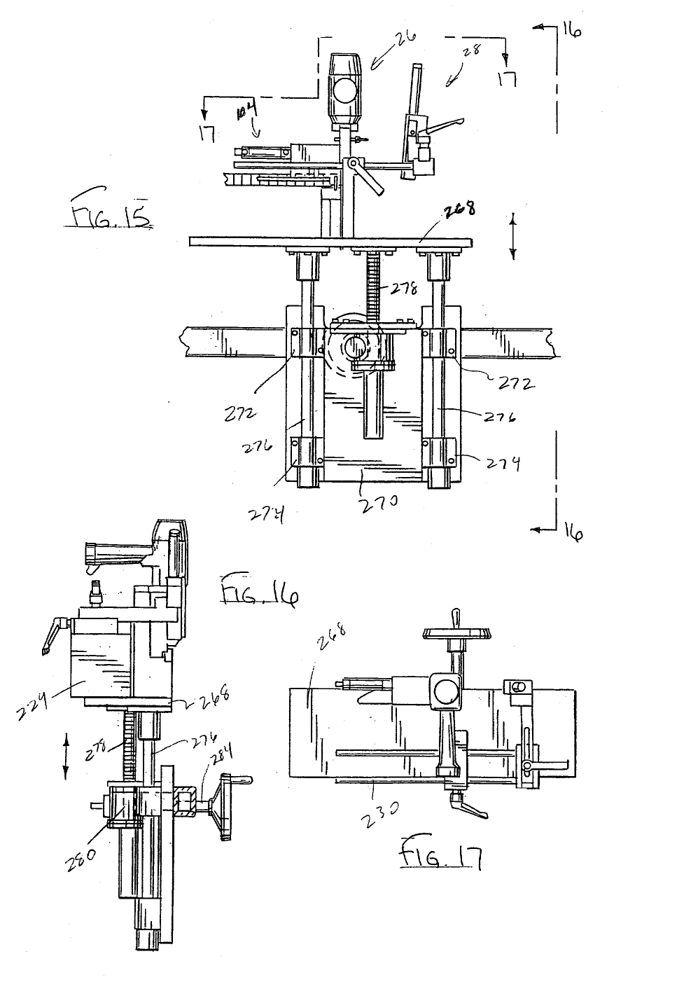

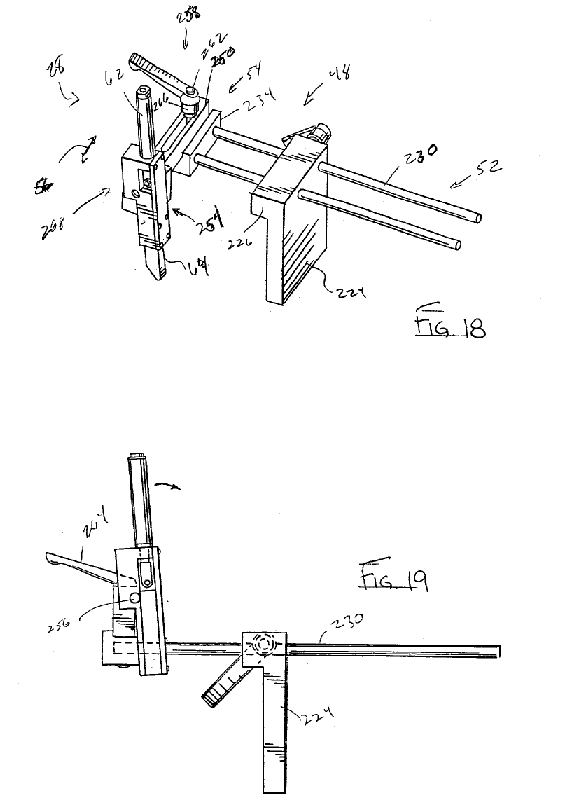

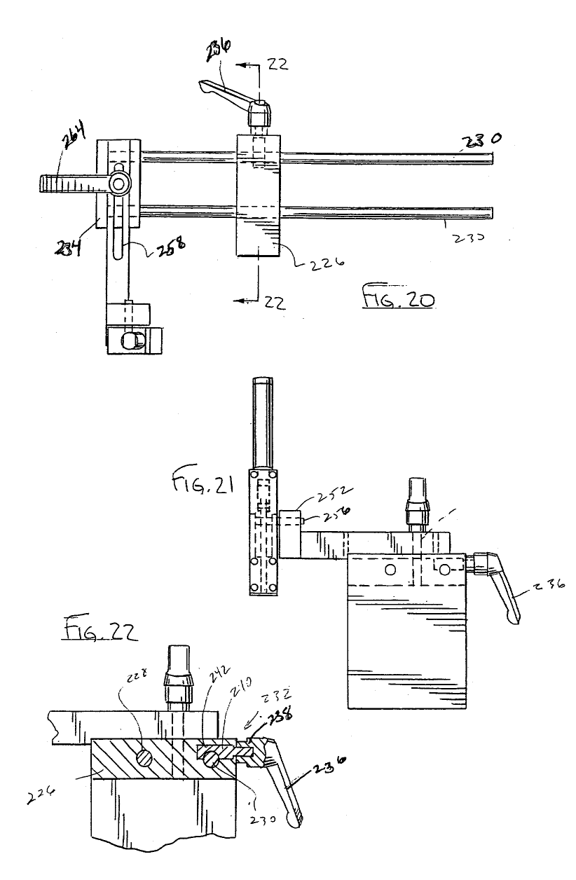

To add further flexibility to the present machine 10, the level adjust mechanism 30 is provided for allowing different thicknesses of wood rails 14 to be clipped therewith without the need for shims or the like, as previously mentioned. In this regard, each of the clipping station 26 including the power tool 32 thereof, the clip sensing assembly 28 including the adjustment mount 48 thereof, the clip feed mechanism 104 and the tray assembly 24 are operably mounted to a vertically adjustable table 268, as best seen in FIGS. 15-17. The level adjust mechanism 30 includes a panel member 270 attached to the inner side of the longitudinal frame members 66, 72 and 74. On the back side of the panel 270 are two sets of upper and lower bearings 272 and 274 for guiding a pair of parallel vertical rods 276 for vertical travel therethrough. At their upper ends, the rods 276 are fastened to the underside of the table 268. Also attached to the underside of the table 268 is an elongate threaded rod 278 which extends between the rods 276 and through a gear housing 280. An adjustment wheel 282 is provided at the front 58 of the machine and has a horizontally extending shaft 284 that it turns. To assist an operator in turning the wheel 282, a wheel crank handle 286 can be provided. The wheel shaft 284 extends through the panel 270 and into the gear box 280 with gearing therein converting rotation of the horizontal shaft to rotation of the screw shaft 278 thus raising or lowering the table 268 relative to the rail guide surface 60. In this manner, the operator can precisely adjust the power tool 32 as well as the other cooperating assemblies to allow clips 12 to be applied to different thicknesses of furniture rails 14 with the present machine 10.

It is manifest that the machine 10 herein can be adapted to apply clips of differing configurations from the clip 12 shown in FIGS. 28-31. For example, FIGS. 32-34 present another type of pronged furniture anchor clip 288 that is commercially in use. Unlike the clip 12, the clip 288 has a generally J-shaped configuration with a base portion 290 and a lower reverse bend or hook portion 292. The base portion 290 has three prongs 294 formed from the base portion 290 leaving a generally pentagonal shaped opening 296. A ram 300 for the clip 288 can be modified over the ram 36 to accommodate the different configuration of the clip 288. For example, because the ram 300 would only be engaging the flat base portion, the bottom 302 thereof need not have a cutout such as the cutout 196 for the ram 36. Also, the raised portion 304 on the ram bottom 302 will be of different shape to match the shape of the opening 296, i.e., pentagonal, in the clip 288.

While there have been illustrated and described particular embodiments of the present invention, it will be appreciated that numerous changes and modifications will occur to those skilled in the art, and it is intended in the appended claims to cover all those changes and modifications that fall within the true sprit and scope of the present invention.

I claim:

1. An apparatus for high speed application of pronged anchor clips to furniture rails, the apparatus comprising:
a frame assembly;
a rail support of the frame assembly having a surface along which a furniture rail can be advanced;
a clipping station at which the rail has anchor clips applied thereto;
a ram for engaging the clips and driving of prongs of the clips into a portion of the rail at the clipping station; and
a fastener power tool mounted to the frame assembly and having a housing and a drive rod actuated by pressurized air for high speed linear reciprocating travel in the housing, the fastener power tool being adapted for high speed advancing and retracting of the ram to provide reduced cycle times for clipping operations.

2. The apparatus of claim 1 including a drive shaft attached to the housing and having walls including inner guide surfaces for guiding the ram into engagement with the anchor clips, and
a quick release attachment of one of the walls to provide access to the ram for maintenance thereon.

3. The apparatus of claim 1 including a clip sensing mechanism downstream of the clipping station, the clip sensing mechanism including a clip engaging portion to be oriented in the path of the clip applied to the rail portion for actuating the power tool and setting a predetermined spacing of clips attached on the rail, and an adjustment mount that allows the clip sensing mechanism to be shifted along the direction of advancement of the rail portion through the clipping station and in a direction transverse to the advancement direction to allow for other than generally straight furniture rails to have clips applied thereto with the predetermined spacing therebetween.

4. The apparatus of claim 3 wherein the adjustment mount is spaced above the rail support to provide a clearance area in which other than straight furniture rails can extend during clipping operations.

5. The apparatus of claim 1 including a clip feed mechanism having a linear actuator that reciprocates a clip engaging member for pushing the clips to the clipping station and a cam at a fixed predetermined position for shifting the clip engaging member out of engagement with clips.

6. The apparatus of claim 1 wherein the power tool includes an adjustment mechanism for changing the relative spacing between the tool and the rail support so that a gap therebetween can be adjusted for clipping of different thicknesses of furniture rails.

7. The apparatus of claim 1 wherein the rail support surface has a width that is minimized in size to allow an operator room to maneuver furniture rails through the clipping station.

8. The apparatus of claim 1 wherein the fastener power tool is capable of cycling the driver between advanced and retracted positions thereof up to thirty times per second.

9. The apparatus of claim 1 wherein the frame assembly includes a primary portion that is an extrusion to provide the frame primary portion with a unitary construction.

10. A method of application of anchor clips to furniture rails, the method comprising:
providing a frame assembly;
orienting a furniture rail so that a portion thereof to be clipped is at a clipping station along the frame;
feeding a leading clip from a string of collated attached clips to the clipping station; and
using a fastener power tool mounted to the frame assembly to drive a ram against the leading clip for attaching the clip to the furniture rail portion.

11. The method of claim 10 including guiding the ram in a drive shaft attached to a housing of the fastener power tool.

12. The method of claim 10 including providing a clip sensing assembly mounted to the frame assembly, and adjusting the clip sensing assembly in at least two directions that are transverse to each other for clipping of nonlinear furniture rails.

13. The method of claim 12 including orienting the sensing assembly above a support surface for the furniture rails to allow a portion of a generally non-linear furniture rail to be oriented thereunder during clipping operations.

14. The method of claim 10 including providing a fixed support surface for guiding the furniture rail thereon to the clipping, and adjusting the power tool to change the spacing between the tool and support surface for clipping of furniture rails of different thicknesses.

15. The method of claim 10 wherein the leading clip is fed by engaging the clip with a pusher that is driven by a power operated linearly reciprocating plunger that moves in the same linear direction as the pusher for advancing the clip to the clipping station.
